(19) United States
(12) Patent Application Publication
(10) Pub. No.: US 2014/0044849 A1
(43) Pub. Date: Feb. 13, 2014

(54) APPARATUS FOR COOKING FOOD

(71) Applicant: Zeeshan Talat Khan, Kuala Lumpur (MY)

(72) Inventor: Zeeshan Talat Khan, Kuala Lumpur (MY)

(21) Appl. No.: 14/002,779

(22) PCT Filed: Feb. 29, 2012
(86) PCT No.: PCT/MY2012/000041

§ 371 Date: Oct. 24, 2013

(30) Foreign Application Priority Data
Mar. 2, 2011 (MY) PI20011000963

(51) Int. Cl. A47J 27/00

(52) U.S. Cl. CPC A47J 27/002
USPC 426/509; 99/403; 99/342

(57) ABSTRACT

The present invention discloses An apparatus for cooking food that is provided with means to regulate the draining of water. The apparatus comprises an outer container (110) with a hollow segment (111) and a base (112), a cylindrical inner container (120) that is removably fitting into the hollow segment (111) of the outer container (110) and a water collecting means (130) which forms a platform of the apparatus. The inner container (120) accommodates a mixture of food (101) and water (102). The apparatus further comprises a heating element (140) positioned underneath the inner container (120) and supported on the base (112) of the outer container (110). In order to drain the water, the apparatus is accommodated with a channel (121) at the bottom of the inner container (120) that funnels to an opening (124). An electromagnetic device (170) is used to regulate the draining of the water (102) by controlling a means for stopping the flow of water. The design of the channel (121) allows an effective draining of water (102) in addition to easy maintenance and cleaning of the apparatus.

### FIELD OF INVENTION

The present invention relates to an apparatus for cooking food. More particularly, the invention relates to an apparatus for cooking starchy food with significantly reduced starch content by regulating the draining of the water from the apparatus before the food is fully cooked using an electromagnetic device.

### BACKGROUND OF THE INVENTION

Rice is a staple food in many countries and is consumed almost always on a daily basis particularly in Asian countries. However, cooked rice contains a high amount of carbohydrate in the form of starch that is produced in the process of cooking the rice. The high carbohydrate content in rice has prevented it from the consumption of people diagnosed with diabetes, obesity and cardiovascular problems. Conventional rice cookers only allow one method to cook rice, in which a certain ratio of rice and water is added into a pot and heated until the rice has absorbed all the water and is deemed cooked. Starch can be categorised into amylose and amylopectin wherein amylose dissolves in the water when rice is being cooked while amylopectin is gelatinised after the rice is being heated. Therefore, the conventional rice cooker would not be able to cook rice in such a way that the starch content is reduced.

In order to lower the amount of starch content in cooked rice, the rice can be rinsed repeatedly before it is cooked and water with the high starch content from the rice can be discarded continuously while the rice is being cooked. This is done manually, by removing the rice cooker pot, discarding the water and continuing the cooking of the rice. However, this may be too cumbersome. Additionally, removing a hot rice cooker pot may cause burnt to the user if not handle properly.

Aside from rice, other starchy staple foods which require boiling are pasta, noodles and the like. These foods are generally boiled in water and while being cooked, they may clump together and not be properly cooked. Furthermore, pasta and noodles alike are very similar to rice in that, cooking them produces a starch content which may not be advisably consumed by people diagnosed with diabetes, obesity and cardiovascular diseases. Therefore, in a similar manner, water used for the cooking of starchy foods such as pasta and noodle needs to be drain to prevent overcooking the food until it becomes clumpy and to reduce the starch content in the cooked food.

If water is drained at an appropriate set time, the amount of starch in the food can be adjusted to the preference of the user. Therefore, food with low starch content can be produced to be consumed by people diagnosed with diabetes, obesity or cardiovascular problems. A number of “healthy” rice cooker patents to produce rice with low starch content have been published wherein all the rice cookers allow water to be discarded at a set time or when requested by the user. However, these rice cookers are provided with means of discarding the water that is designed merely to serve its purpose but does not cater to an effective cleaning of the water discarding means. Since starch water is being discarded regularly by the rice cooker, there must be a simplified way to clean the water discarding means to prevent fungi from growing and dirt from collecting at the water discarding means. This is essential to ensure that the rice being cooker is not contaminated with bacteria and germs.

US patent publication 2007/0190221 disclosed a method for removing starch in rice and an accompanying cooking device that carries out the method. The rice cooker of the invention is basically a conventional rice cooker, adapted with a water replenishing means and a water discarding means to discard starch water while the rice is being cooked. The water is discarded through a valve located towards the side of the inner pot. The location of the valve causes water to be ineffectively discarded. The design of the inner pot of the rice cooker is such that, when the valve is opened for water to be discarded, only water from the segment closest to the valve can be discarded. Starch water is therefore collected at the segment furthest from the valve and cannot be effectively discarded thus causing an uneven cooking of rice and further, rice that still contains a high amount of starch. The valve is mounted within the casing and it would seem that the most feasible way to actually remove the valve for regular cleaning would be to dismantle the rice cooker. This is time consuming and is troublesome particularly to users who are not electrical appliances savvy.

US patent publication, 2005/0120887 disclosed yet another rice cooker with the capability to discard water using a solenoid valve with a manual override lever. The solenoid valve and the manual override lever are accommodated at the base of the inner pot. The valve is mounted within the rice cooker and it seems that the only way to clean the valve is to detach the rice cooker itself which would be cumbersome. Furthermore, the valve provided has a very thin duct which allows water to be discarded as individual drips from the rice cooker. The water cannot be eliminated effectively due to the size of the duct also because atmospheric pressure may prevent the water from being continuously discarded. Further, if the water is discarded in such a manner, the starch in the water would eventually stick to the rice because water is being discarded at such a slow rate. Additionally, the invention includes a manual override lever that is contained within a water reservoir and cannot be manually controlled by the user as there are no perforations at the water reservoir to allow access to the user to control the lever. There is also no indication that the lever is controlled by some electrical means.

Malaysian patent publication MY-20030968-P disclosed yet another rice cooker with a means to discard water through a vacuum tube and a vacuum pump unit. The vacuum pump does not provide the most effective way to discard the water because the vacuum tube is merely located at one side of the rice cooker. Therefore, the vacuum mechanism would only end up extracting starch water from one side of the rice cooker causing uneven starch content throughout the cooked rice. Furthermore, having a vacuum pump would require more power as water is being sucked out against gravity. A vacuum pump can also be very audible could be displeasing to the users' hearing.

Therefore, there is a need for an apparatus for cooking food with a reduced starch content, achieved by regulating the draining of the water from the apparatus before the food is fully cooked using a water discarding means which is easy to be cleaned and encourages an effective flow of water.

### SUMMARY OF INVENTION

Accordingly, it is a primary object of the invention to provide an apparatus for cooking food with significantly reduced starch content.

It is another object of the invention to provide an apparatus for cooking food that regulates the draining of the water from the apparatus before the food is fully cooked using an electromagnetic device.

It is another object of the invention to provide an apparatus for cooking food that is accommodated with a channel which funnels to an opening to effectively drain the water from the mixture of water and food.

It still another object of the invention to provide an apparatus for cooking food that is easy to be maintained and cleaned, without having to dismantle the whole apparatus.

It is yet another object to the invention to provide an apparatus for cooking food that allows the user to set a starch content percentage in the cooked food.

To fulfill the aforementioned objectives an apparatus for cooking food with means to regulate the draining of water is utilised. The apparatus comprises an outer container with a hollow segment and a base, a cylindrical inner container that is removably fitting into the hollow segment of the outer container and a water collecting means which forms a platform in which the outer container sits on. The inner container accommodates a mixture of food and water. The apparatus further comprises a heating element positioned underneath the inner container and supported on the base of the outer container. In order to drain the water, the apparatus is accommodated with a channel that funnels to an opening. An electromagnetic device is used to regulate the draining of the water by controlling a means for stopping the flow of water. The design of the channel allows an effective draining of water in addition to easy maintenance and cleaning of the apparatus.

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 is a cross sectional view of an apparatus for cooking food (housing is not shown);

FIG. 2 shows the apparatus while water is being drained (housing is not shown); and

FIG. 3 is a flow chart that illustrates the options of the apparatus selectable by a user.

### DETAILED DESCRIPTION OF THE INVENTION

The present invention relates to a food cooking apparatus. Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

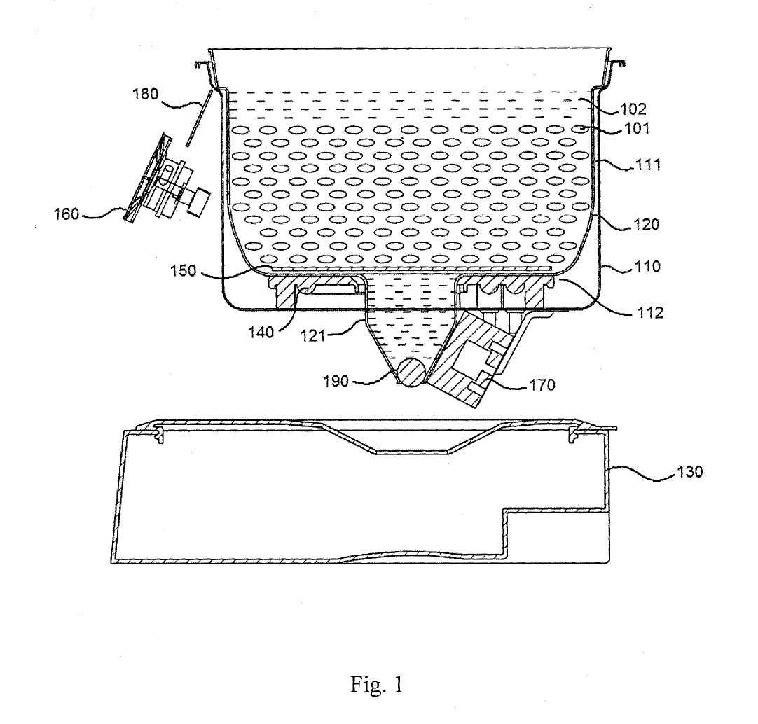

Referring now to FIG. 1, there is shown a cross sectional view of an apparatus for cooking food. The apparatus comprises an outer container (110) with a hollow segment (111) and a base (112), a cylindrical inner container (120) that is removably fitted into the hollow segment (111) of the outer container (110) and a water collecting means (130) which forms a platform of the apparatus. The water collecting means (130) is positioned below the outer container (110). The inner container (120) accommodates a mixture of food (101) and water (102). The food (101) may be starchy food such as rice, noodles and pasta, but are not limited to these examples. The apparatus further comprises a heating element (140) positioned underneath the inner container (120) and supported on the base (112) of the outer container (110).

The apparatus additionally comprises a housing (not shown) which houses the outer container (110) and an electronic controller (160) with a display screen (180) being accommodated at the side of the outer container (110). The apparatus further comprises a lid (not shown), hinged on the edge of the housing (not shown) adjacent to the opened end of the hollow segment (111) for covering the inner container (120) when the food is being cooked. The housing and lid is not shown in FIG. 1 to produce a clearer figure of the apparatus with the most essential components.

A channel (121) is provided at the bottom of the inner container (120) to allow the water (102) to be drained out. To ensure that food (101) is not drained together with the water (102), a meshed surface (150) is placed at the bottom of the inner container (120). Therefore, the meshed surface (150) would support the food (101) directly above the channel (121), allowing only the water (102) to be drained while the food (101) stays in the inner container (120).

The channel (121) of the inner container (120) is fitted and protrudes through an opening at the base (112) of the outer container (110). The water collecting means (130) is provided with an opening which is positioned directly below the channel (121) such that when the water is drained from the inner container (120) through the channel (121), it is collected at the water collecting means (130). The channel (121) is held a distance away from the opening of the water collecting means (130) by the housing (not shown). The water collecting means (130) is placed separately and not in contact with the electrical components of the apparatus to minimise the risk of damaging them. The water collecting means (130) is essentially a reservoir for containing the drained water (103) temporarily and is detachable from the housing (not shown) to be emptied when necessary.

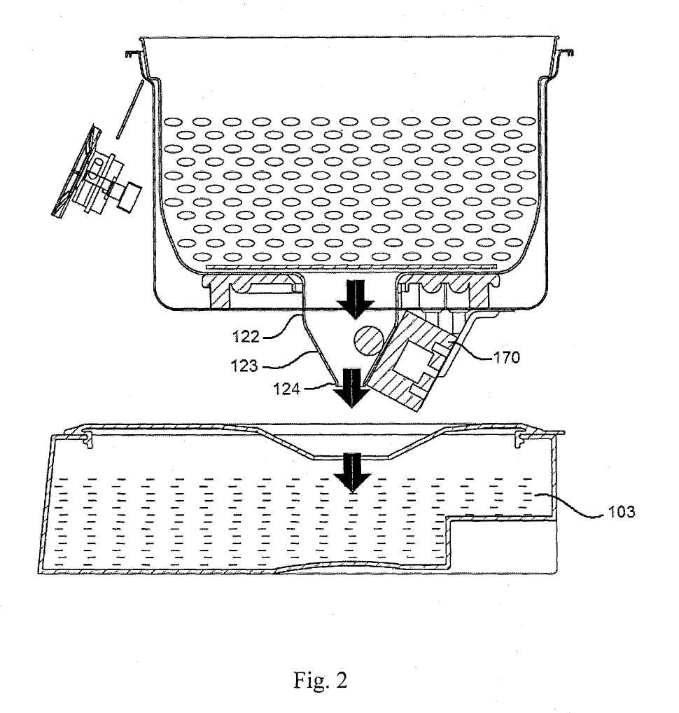

As shown in FIG. 2, the channel (121) is preferably formed at the centre of the inner container's bottom and funnels to an opening (124) at a distal end of the channel (121). In a preferred embodiment, the channel (121) comprises a cylindrical segment (122) and a cone-shaped segment (123) which funnels to the opening (124) at its tip. The shape of the channel (121) which is similar to that of a funnel allows the draining of the water to be more effective because the space provided by the cylindrical segment (122) allows the water (102) to be temporarily held before it is discarded through the opening (124). This encourages a continuous flow of water.

The heating element (140) of the present invention are preferably heating coils which are mounted against the outer surface of the bottom of the inner container (120) such that heat can be transferred efficiently from the heating element (140) to the inner container (120) via conduction to cook the food as shown in FIG. 1. The heating coils surround the cylindrical segment (122) of the channel (121).

Still referring to FIG. 1, the apparatus is provided with an electromagnetic device (170) and a means for stopping the flow of water through the opening (124) of the channel. The means for stopping the flow of water is preferably a metal ball (190). The metal ball (190) is preferably spherical but may be ellipsoidal or any appropriate shape to stop the flow of water through the channel (121). The electromagnetic device (170) and the metal ball (190) work in tandem to stop or allow the flow of water through the channel (121). Since the channel (121) funnels the flow of the water through the cone-shaped segment (123) in a continuous manner, the metal ball (190) stops the flow by closing the opening (124) at the tip of the cone-shaped segment (123). The metal ball (190) is fabricated such that it is slightly bigger than the opening of the channel (121). The diameter of the metal ball (190), is larger than the diameter of the opening (124), therefore, when the apparatus is arranged in an upright manner, gravitational pull would cause the metal ball (190) to roll towards the funnel opening (124), at a neutral position.

The electromagnetic device (170) is mounted to the outer surface of the channel (121) and abuts the cone-shaped segment (123). Therefore, the electromagnetic device (170), does not, in any way, come in contact with the water to avoid damaging it. The electromagnetic device (170) regulates the water that is being drained by controlling metal ball (190). As shown in FIG. 1, with the electromagnetic device (170) turned off, the metal ball (190) would naturally sit between the edges of the channel's opening (124), stopping the flow of water (102) through the opening (124). Upon turning on the electromagnetic device (170), the metal ball (190) is magnetically pulled towards the proximity of the electromagnetic device (170) therefore retracting it from closing the opening (124) of the channel (121) as shown by FIG. 2. With the metal ball (190) retracted, water flows through the channel (121) from the inner container (120) to the water collecting means (130).

The metal ball (190) can be easily removed from the channel (121) to be cleaned and does not require cumbersome dismantling of the apparatus. To remove the metal ball (190), the user only needs to, remove the meshed surface (150) from the bottom of the inner container (120).

The food cooking apparatus works as a typical household food cooker that can be used for cooking rice, noodles, pastas and the like but has an additional feature of regulating the draining of water from the food being cooked to ensure that the cooked food is properly cooked and has low starch content. The cooking of the food is achieved by filling the inner container (120) with a preferred ratio of food and water, closing the lid and selecting a preferred cooking option.

In a preferred embodiment, water can be added continuously to the food while it is being cooked to replace the drained water. That way, the food can be continuously rinsed such that the starch contained in the water and the food can be removed through different stages of rinsing. Water may be added to the food via a duct (not shown) which extracts clean water from a clean water storage (not shown). Clean water may be sprayed into the inner container as water droplets or flowed into the inner container from the wall of the inner container through a plurality of small water inlets.

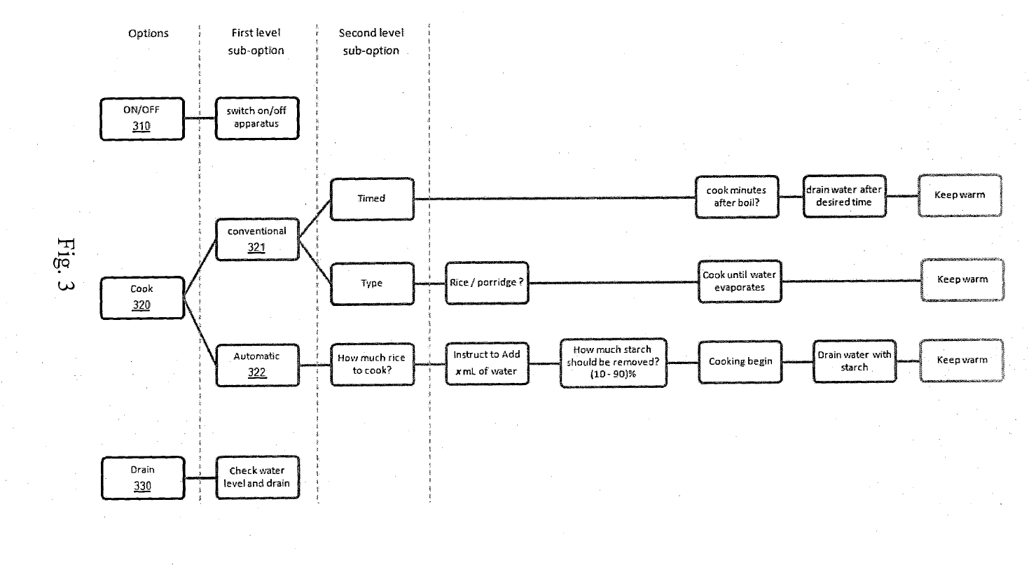

The electronic controller (160) and the corresponding display screen (180) enable the user to select a preferred cooking option. Referring now to FIG. 3, there is shown a flow chart that illustrates the options selectable through the electronic controller (160).

A first option (310) is switching the apparatus on or off through an on/off switch.

A second option (320) is a standard cooking of the food. Upon selection of the second option (320), the user would be prompted to select whether to cook the food conventionally or automatically.

Selecting the conventional sub-option (321) would allow the user to choose whether to cook the food based on a preset time or the type. This sub-option allows for the cooking of food with normal starch content. By selecting the timed sub-option, the user can choose the amount of time to cook the food after the water has boiled and a selected time to drain the water before keeping the food warm. By selecting the type sub-option, the user merely needs to select if cooked rice or porridge (congee) is desired. Additionally, the type sub-option may also include options applicable to noodles and pasta. The electronic controller (160) is pre-programmed with an average time of cooking rice or porridge (congee) and would therefore cook the rice until the water fully evaporates and a desired rice type is produced and is kept warm. The cooking time may also be pre-programmed for other food types such as noodles and pasta.

Selecting the automatic option (322) would prompt the user to input the amount of food that is to be cooked, preferably in the form of the weight or volume. This option would allow the user to specify the starch content in the food being cooked, which is preferably lower than the normal starch content. Once the amount of food is keyed in, the electronic controller (160) would instruct the user to manually add a specified amount of water into the food preferably in millilitres. The user selects a desired starch content, which indicates much how starch is to be removed and a cooking of the food would begin. The starch content selectable by the user is preferably represented in terms of percentage (10 percent to 90 percent) of starch in the cooked food. The water with starch is subsequently drained by regulating the electromagnetic device (170) and the metal ball (190). The electromagnetic device (170) would be activated after a period of time to ensure that an appropriate amount of water is drained to produce food of a particular percentage of starch. Once the food is cooked, it would be kept warm.

A third option (330) allows the user to check the level of water while the food is being cooked at any point of time and drain the water manually.

Although this disclosure has described and illustrated certain preferred embodiments of the invention, it is to be understood that the invention is not restricted to those particular embodiments. Rather, the invention include all embodiments which are functional or mechanical equivalence of the specific embodiments and features that have been described and illustrated.

1. An apparatus for cooking food which significantly reduced starch content comprising;
an outer container having with a hollow segment and a base;
an inner container removably fitting into the hollow segment;
a water collecting means that forms a platform for the apparatus and positioned below the outer container; and
a heating element positioned underneath the inner container and supported on the base of the outer container;
wherein a channel is provided at the bottom of the inner container to allow water to be drained out wherein the channel funnels to an opening at a distal end;
a meshed surface is placed at the bottom of the inner container to support the food directly above the channel ; and
an electromagnetic device is mounted on the outer surface of the channel for regulating the water that is being drained out from the opening by controlling a means for stopping the flow of water.

2. The apparatus for cooking food according to claim 1, further comprising;
a housing which houses the outer container and is attached to the water collecting means; and
a lid, hinged on the edge of the housing and is adjacent to the opened end of the hollow segment for covering the inner container when the food is being cooked.

3. The apparatus for cooking food according to claim 1, further comprising an electronic controller with a display screen for allowing the user to select a preferred option.

4. The apparatus for cooking food according to claim 1, wherein the heating element are heating coils mounted against the outer surface of the bottom of the inner container such that heat can be transferred efficiently from the heating element to the inner container.

5. The apparatus for cooking food according to claim 1, wherein the channel comprises a cylindrical segment and a cone-shaped segment which funnels to the opening at its tip.

6. The apparatus for cooking food according to claim 1, wherein the means for stopping the flow of water is a metal ball which has a slightly bigger diameter than the opening such that the opening is fully closed by the metal ball at a neutral position.

7. A method for cooking food with significantly reduced starch content comprising the steps of:
providing an apparatus comprising:
an outer container having with a hollow segment and a base;
an inner container removably fitting into the hollow segment;
a water collecting means that forms a platform for the apparatus and positioned below the outer container; and
a heating element positioned underneath the inner container and supported on the base of the outer container;
wherein a channel is provided at the bottom of the inner container to allow water to be drained out wherein the channel funnels to an opening at a distal end;
a meshed surface is placed at the bottom of the inner container to support the food directly above the channel; and
an electromagnetic device is mounted on the outer surface of the channel for regulating the water that is being drained out from the opening by controlling a means for stopping the flow of water;
filling the inner container with food and a specified amount of water;
switching the heating element on to cook the food;
turning the electromagnetic device on to retract the means for stopping the flow of water from closing the opening of the channel;
draining the water from the inner container; and
turning the electromagnetic device off after a set period of time to return the means for stopping the flow of water to a neutral position to stop the draining of the water.

8. The method according to claim 7, wherein the set period of time is determined by the percentage of starch content selectable by the user.
